(19) United States
(12) Patent Application Publication
(10) Pub. No.: US 2024/0230102 A9
(43) Pub. Date: Jul. 11, 2024

(54) AIR CANNING METHOD AND APPARATUS

(71) Applicant: Electrolux Home Products, Inc., Charlotte, NC (US)

(72) Inventors: Michael D. Padgett, Springfield, TN (US); Andre Garcia, Hendorsonville, TN (US)

(21) Appl. No.: 18/276,702

(22) PCT Filed: Feb. 24, 2022
(86) PCT No.: PCT/US2022/017670

§ 371 Date: Aug. 10, 2023

Related U.S. Application Data
(60) Provisional application No. 63/157,042, filed on Mar. 5, 2021.

(51) Int. Cl. F24C 7/08

(52) U.S. Cl. CPC F24C 7/087; F24C 7/085

(57) ABSTRACT

A method is disclosed for air canning food in an oven cavity (12), where air, not water, is the cooking medium. Using a dedicated air canning algorithm, a temperature of the oven cavity (12) is adjusted in a plurality of temperature and/or time regulated canning stages. An initial pre-heat stage targets a preheat temperature and can maintain the preheat temperature for a predetermined period of time to achieve container (12) sterilization. A subsequent post-heat (canning) stage maintains the cavity at a postheat (canning) temperature to effectively can food. A specialized air canning rack (100) permits the hot, circulating air to freely access substantially the entire periphery of the canning containers (12) during the air canning process.

### FIELD OF THE INVENTION

The present disclosure is directed to an air canning method and apparatus. More specifically, the disclosure is directed to an apparatus and a method for air canning and a specialized rack for use therewith.

### BACKGROUND

Conventionally, canning is carried out by placing jars filled with food items to be preserved into water baths, which are held at a constant, boiling temperature for a period of time in order to neutralize bacteria. However, canning in water baths is often a messy process. Moreover, canning low-acidity foods requires higher-temperature processing and typically necessitates the use of specialized pressure-canning equipment capable of boiling water at temperatures above 212° F. (e.g., the boiling point of water at atmospheric pressure).

### BRIEF SUMMARY

The instant apparatus and method utilize a high-performance convection system that circulates heated air within an oven cavity without the use of a liquid medium or additional cooking utensils to hold a liquid medium. This method can also be used to can goods at higher temperatures than can be achieved on a cooktop, which is limited to the boiling point of water unless pressurized canning vessels or other liquid media with higher boiling points are used. The air canning method regulates the convection system through the use of a PID controller that tightly controls the temperature in the oven cavity, which is desirable to eliminate bacteria and prevent discoloration, change in taste, and loss of nutrients in the food(s) to be canned. A canning rack capable of holding an array of containers and adapted to be supported on opposing sidewall rack supports in an oven cavity is also provided for. The rack is specially configured so that the canning medium (e.g., hot, circulating air) can freely access substantially the entire periphery of the respective containers.

A cooking method performs air canning in an oven cavity of a cooking appliance, where hot air, rather than a liquid, serves as the canning medium. Using a dedicated air canning algorithm to control at least one heating element and an associated fan (e.g., the convection system), the oven cavity can be heated to and maintained at a constant temperature near a target set point for a predetermined or user-selected period of time. An initial pre-heat stage for pre-heating the oven cavity and sanitizing empty containers includes temperature control targeting a predetermined temperature, which can include a predetermined oven cavity temperature plus an offset. A subsequent post-heat stage for canning a food item can target the same predetermined temperature plus offset. At least one heating element and the associated fan are operated during the post-heat stage, preferably in accordance with PID-control.

According to an aspect, a method for air canning food in a kitchen range includes (a) receiving a user selection to activate an air canning mode including a pre-determined plurality of sequential heating stages, (b) loading empty containers into the specialized rack and inserting the rack into the oven cavity, and (c) heating an oven cavity of the kitchen range during a first pre-heat stage of the plurality of sequential heating stages targeting a predetermined preheating temperature (which can include a setpoint plus an offset), and operating the convection fan and at least one heating element according to a pre-heat duty cycle to maintain the oven cavity at the preheating temperature for a predetermined period of time. The method further includes (d) removing the specialized rack containing empty (now-sterilized) containers from the oven cavity and filling the empty containers with food(s) to be canned, and (e) returning the specialized rack holding the containers filled with food back into the oven cavity and thereafter canning the food within the oven cavity during a post-heat stage of the plurality of sequential heating stages, where during said post-heat stage a convection fan and at least one heating element are operated according to a post-heat duty cycle to maintain the oven cavity at a predetermined postheat/canning temperature, which can include the setpoint plus the offset. That is, the preheat and postheat temperatures can be the same.

According to another aspect, a method for air canning a food item in an oven cavity of a kitchen range is provided. The method includes initially heating the oven cavity to target a predetermined temperature during a first pre-heat stage via feedback control based on temperature parameters, subsequently heating the oven cavity during a post-heat stage to target the predetermined temperature via feedback control based on at least a temperature parameter, said oven cavity being heated during said post-heat stage according to PID-control during which a fan is operated for a full duration and at least one heating element may be cycled on and off.

The foregoing and other features of the invention are hereinafter described in greater detail with reference to the accompany drawings.

### BRIEF DESCRIPTION OF THE DRAWINGS

The accompanying drawings, which are not necessarily to scale, show various aspects of the disclosure.

FIG. 1 schematically illustrates a side cross-section of a cooking appliance used for air canning;

FIG. 2 schematically illustrates a control system of the cooking appliance of FIG. 1;

FIG. 3 illustrates an example method for carrying out an air canning operation in the cooking appliance of FIG. 1;

FIG. 4 illustrates a portion of an example method for carrying out the air canning operation in the cooking appliance of FIG. 1;

FIG. 5 illustrates a portion of another example method for carrying out the air canning operation in the cooking appliance of FIG. 1; and

FIG. 6A illustrates a first perspective view of an empty canning rack designed to hold containers during air canning in the cooking appliance of FIG. 1;

FIG. 6B illustrates a second perspective view of the rack in FIG. 6A;

FIG. 6C illustrates the rack of FIG. 6A having containers held in some of the receptacles thereof;

FIG. 7A illustrates the rack of FIG. 6A after insertion into the oven cavity of the cooking appliance of FIG. 1;

FIG. 7B illustrates a rack partially filled with canning containers after insertion into the oven cavity of the cooking appliance of FIG. 1;

### DETAILED DESCRIPTION

The present disclosure relates to a method for air canning a food item using a kitchen range, a kitchen range having a dedicated air canning capability, and a wire rack for use in a kitchen range with air canning capabilities. Rather than using a traditional liquid bath, hot air, is used as a canning medium. A food item can be canned without a liquid medium or a utensil for holding liquid medium, resulting in a cleaner and more efficient canning process. Unlike canning on a cooktop where the maximum temperature is limited to the boiling point of water unless pressurized canning vessels or other liquid media with higher boiling points are used, canning in a kitchen range can be performed at higher temperatures. Providing for air canning in the kitchen range also avoids the use of miscellaneous equipment (e.g., pressurized canning vessels), saves valuable counter space and adds versatility to the kitchen range.

Generally, a gas or electric kitchen range, as opposed to a countertop appliance, has a convection system and one or more additional heating elements configured to execute an air canning program or mode according to a dedicated air canning algorithm. The air canning algorithm utilizes a convection fan of the convection system to provide a generally uniform convective air-temperature throughout the associated oven cavity, in combination with temperature and/or time-controlled heating stages. During at least one of the stages, the convection fan and at least one or more of the heating elements are operated according to a proportional-integral-derivative (PID) algorithm based on temperature feedback measured in the cavity.

The air canning method can be carried out with a cooking range, also herein referred to as a kitchen range, or a similar cooking appliance that is capable of regulating the temperature of an oven cavity at a set point and evenly or uniformly heats the oven cavity. In general, cooking ranges have an oven cavity including one or more heating elements (e.g., bake, broil, and convection elements). A controller (e.g., having a processor and memory) controls the power to the heating elements and/or other elements of the range such as convection fans. A temperature sensor may also be disposed in the cooking range for measuring the temperature of the oven cavity and providing the measured temperature as a feedback signal to the controller. Utilizing these and other elements, the controller may operate the cooking appliance in accordance with a cooking program.

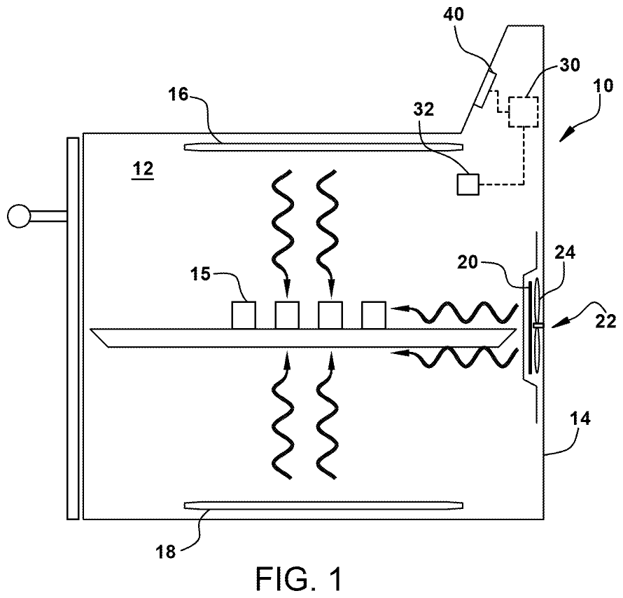

Turning now to FIG. 1, a cooking appliance 10, such as a kitchen range, is illustrated having the above-identified fan and heating elements for heating an interior oven cavity 12 defined by an appliance cabinet 14. A container 15 (which may be ajar containing a food to be canned) is illustrated within the oven cavity 12. The heating elements for heating the oven cavity 12 and the container 15 can include a broil heating element 16, a bake heating element 18, and a convection heating element 20.

The convection heating element 20 is part of a convection heating system 22 including the convection heating element 20 and a convection fan 24. Rotation of an impeller of the fan 24 enables distribution of heat provided by the convection heating element 20, and also by the broil and bake heating elements 16 and 18, throughout the oven cavity 12. Employing a convection fan to circulate air in a small, confined space such as an oven produces substantially uniform air distribution, which enables saturation of the cavity 12 with evenly heated air. Coupled with PID control, such a convection system can yield a precisely controlled constant temperature profile suitable for canning, e.g. in the range of 210° to 250° F., more preferably 230° to 250° F.

While the convection fan 24 is shown as being disposed adjacent the convection heating element 20, the fan 24, or another fan, may be otherwise disposed elsewhere within or relative to the oven cavity, such as not being specifically associated with the convection heating element 20. One or more additional heating elements may be provided in other embodiments, and/or one or more of the heating elements 16, 18 and 20 may be omitted.

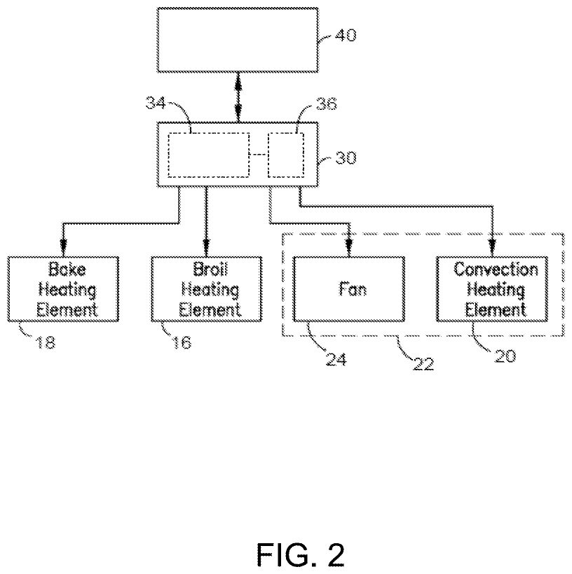

The cooking appliance 10 includes a control system 30, schematically illustrated at FIG. 2, for controlling operation of the heating elements 16, 18, and 20 and of the fan 24. As will be understood by one having ordinary skill in the art, the control system 30 of the cooking appliance 10 can be configured to operate any one of the heating elements 16, 18 and 20 and the fan 24 separately from one another or in conjunction with any one or more of the other of the heating elements 16, 18 and 20 and the fan 24. To provide this control, the control system 30 is communicatively connected to each of the heating elements 16, 18, and 20, to the fan 24, and to at least one sensor 32 (FIG. 1) disposed in the oven cavity 12 to monitor the temperature of the oven cavity 12. The control system 30 includes at least a processor 34 and a storage 36, such as a memory, which in other embodiments may be integral with the processor 34.

A “processor” as used herein refers to any, or part of any, electrical circuit comprised of any number of electrical components, including, for example, resistors, transistors, capacitors, inductors, and the like. The circuit may be of any form, including, for example, an integrated circuit, a set of integrated circuits, a microcontroller, a microprocessor, a collection of discrete electronic components on a printed circuit board (PCB) or the like. The processor may also stand alone or be part of a computer used for operations other than those of a cooking appliance. Implementation of these aspects may by hardware or software may be realized in any number of electronic devices and/or applications, including but not limited to, personal computers, servers, mobile phones, and the like. Moreover, the above aspects and/or combination of aspects may be stored in memory which is executable by one of said processors. It is also to be noted that the above description is non-limiting, and the examples are but only a few of many possible processors and implementations envisioned.

The storage 36 can include any suitable architecture for storing information to assist with operation of the cooking appliance 10. The storage 36 can provide a non-transient computer readable medium for containing program instructions for causing the processor 34 to perform one or more steps of one or more cooking methods. For example, program instructions for implementing an air canning algorithm for heating the container (with or without food to be canned) 15 within the oven cavity 12 may be included in the storage 36 and read and/or implemented by the processor 34.

Initiation of the air canning algorithm and/or setting or choosing an air canning cooking temperature may be caused by a user activating a control panel 40 of the control system 30. In other embodiments such actions may be implemented via an email, a mobile device, etc., where the control system 30 is suitably configured to receive said signal(s), data, etc.

The control system 30 further may be communicatively connected to a user feedback architecture, such as a display, auditory element or tactile element, for providing one or more of visual, audible or tactile feedback to the user. The feedback architecture may be integral with the illustrated control panel 40 or may be separately disposed in other embodiments. The feedback may include a notice that the container 15 (or the cavity 12 in which it resides) has been heated to a desired temperature and is ready to be filled with a food item to be canned, such as upon completion of a pre-heat stage of an air canning mode, for example.

Turning again to FIG. 1, the cooking appliance 10 depicted may be an electric or a gas cooking appliance and thus the air canning algorithm described below may be implemented by either of an electric kitchen range or a gas kitchen range. In either case, an air canning mode of the respective kitchen range is activated based on a user input selecting an ‘Air Canning’ mode, causing the control system 30 to implement the dedicated air canning algorithm. Upon selecting the ‘Air Canning’ mode, the air canning algorithm operates at least one heating element and the convection fan to target a preheat temperature, which can include an offset. In one embodiment, the selection of ‘Air Canning’ mode targets a temperature in the range of between about 200° F. to about 300° F., about 205° F. to about 280° F., about 215° F. to about 260° F., or about 230° F. to about 250° F. In another embodiment, the user may be prompted to select a food to be canned. For example, in one embodiment, the user may be asked to select from among “Fruits,” “Vegetables,” “Meat,” “Poultry,” “Seafood,” “Jams/Jellies,” “Pickles/Fermented Products,” or any subset of foods that are commonly canned. In this embodiment, each food selection corresponds to a predetermined suitable air canning temperature over a predetermined period of time. In another embodiment, the user may be asked to select from “Acidic Foods” or “Non-Acidic Foods.” In this embodiment, the selection of “Acidic Foods” executes a function to target a predetermined suitable air canning temperature for canning acidic foods (e.g., about 212° F.), and the selection of “Non-Acidic Foods” executes a function to target a predetermined suitable air canning temperature for non-acidic foods (e.g., about 250° F.), optionally for a set period of time. In another embodiment, the user may be simply be asked to input or select a desired air canning temperature and a desired air canning time. Alternatively, the canning stage of the algorithm may be operated indefinitely until stopped by the user.

Once activated, the range executes the air-canning algorithm to can foods via convective air in the oven cavity. The air canning algorithm may have one or more different steps, temperatures, times, other aspects, etc. depending on whether the range is electric or gas. However, both the electric and gas algorithms will operate at least one of heating elements 16, 18 and 20, in conjunction with the fan 24 to cause heating of the oven cavity 12 and resultant air canning of the food item.

### Air Canning Method

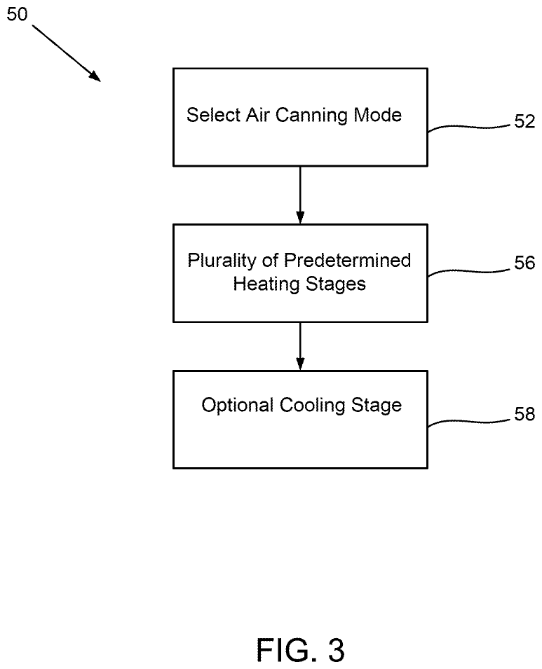

Referring now to FIG. 3, generally, an air canning method 50 for canning food in a cooking appliance 10, such as a kitchen range, and using the air canning algorithm of the present application, is illustrated. The exemplary air canning method is illustrated as a series of blocks. The method is not limited to the specific blocks shown or to the specific order of the blocks shown.

The illustrated method 50 includes an initial step 52 of selecting an ‘Air Canning’ mode including a dedicated and pre-determined plurality of sequential heating stages. At step 56, using the air canning algorithm described herein the oven cavity 12 is heated and the food item is canned during at least one of the pre-determined plurality of sequential heating stages. The pre-determined plurality of heating stages can include a pre-heat stage and a subsequent post-heat (or ‘canning’) stage.

A total length of step 56 is can be indefinite, with at least an ultimate (i.e. final) post-heat stage of the air canning algorithm operating indefinitely until stopped. In some embodiments, the control system may allow for an overall operation time of the ‘Air Canning’ mode, where the ‘Air Canning’ mode is stopped upon completion of the overall operation time.

During the plurality of heating stages, feedback control for operating the heating elements 16, 18 and 20 and the fan 24 may be provided by both time and temperature parameters, where each respective heating stage of step 56 includes feedback control provided by at least a temperature parameter, but in some stages, which may be optional, also according to a time parameter. Specifically, during each of the heating stages, one or more of the plurality of heating elements 16, 18 and 20 at least is operated with temperature control, and may be operated with temperature control according to a stage-specific timed duty cycle. Each, or fewer than each, of the heating stages may include operation of a plurality of the heating elements 16, 18 and 20.

Additionally, when operated, each of the broil, bake and convection heating elements 16, 18 and 20 will be run at a constant power level, rather than varying voltage or power supplied to the heating elements. To adjust the overall power output in a given canning stage, the element(s) preferably is/are operated according to the respective stage-specific timed duty cycle, but when active each element operates at constant power.

Also, each, or fewer than each, of the heating stages may include operation of the fan 24. Generally, however, the fan preferably is operated full-time during at least the post-heat (canning) stage when food products are actively being canned.

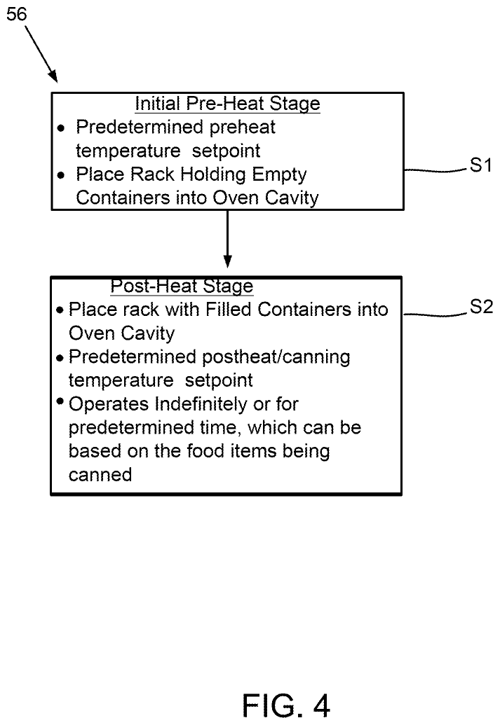

Referring now to FIG. 4, step 56 of the illustrated air canning method of FIG. 3 is further detailed via illustration of substeps including the plurality of sequential heating stages according to the air canning algorithm initiated at step 52.

At an initial pre-heat stage S1, the oven cavity 12 is pre-heated by running at least one of the plurality of heating elements 16, 18 and 20 to approach and preferably achieve a predetermined temperature during a duty cycle bound by a finite timed parameter. Alternatively, in some embodiments, the initial pre-heat stage S1 can be carried out until the predetermined first target temperature actually is achieved without being bound by a finite timed parameter. The predetermined temperature preferably is in a range that is suitable for sterilizing containers in preparation for canning foods. Generally, the containers 15 for use in the air canning process are jars made of glass, such as mason jars. However, is appreciated that the containers 15 are not limited to glass jars, and may be made of any material conventionally used in canning, including, but not limited to, aluminum, tin-coated steel (tinplate), electrolytic chromium coated steel (ECCS), or mixtures thereof. Heating empty containers 15 in the oven cavity 12 during the initial pre-heat stage can be used to kill bacteria that may be present therein (e.g., sterilization). Gradually preheating the jars also minimizes the risk of them breaking or cracking during the post-heat (canning) stage. In some embodiments, the preheat temperature may be between about 135° F. to about 300° F., about 170° F. to about 280° F., about 200° F. to about 260° F., or about 230° F. to about 250° F.

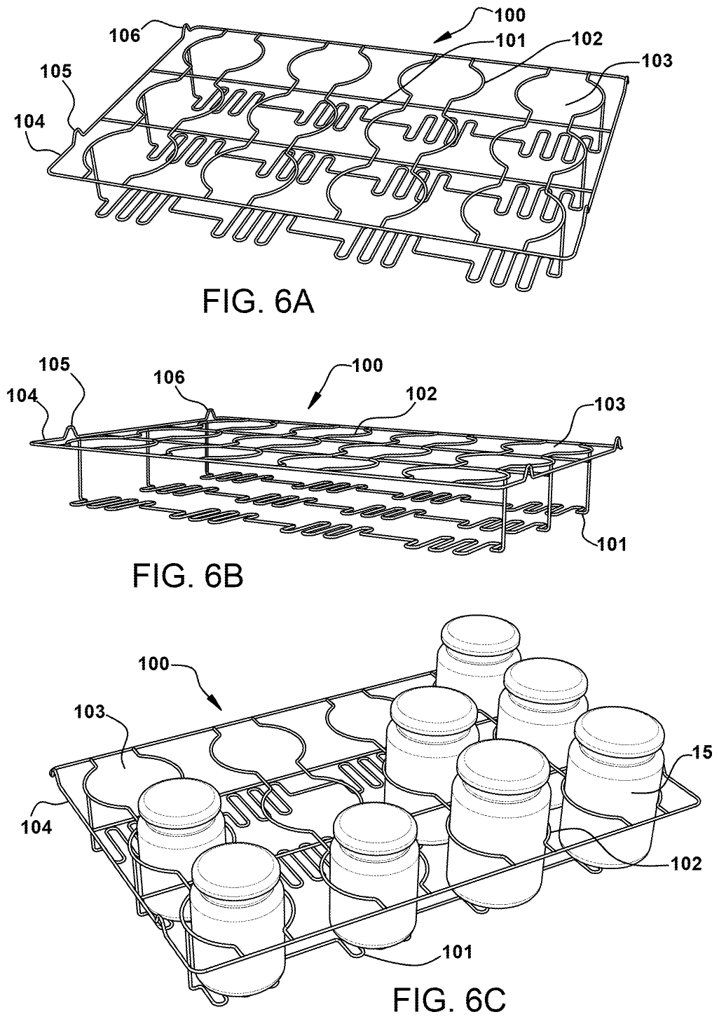

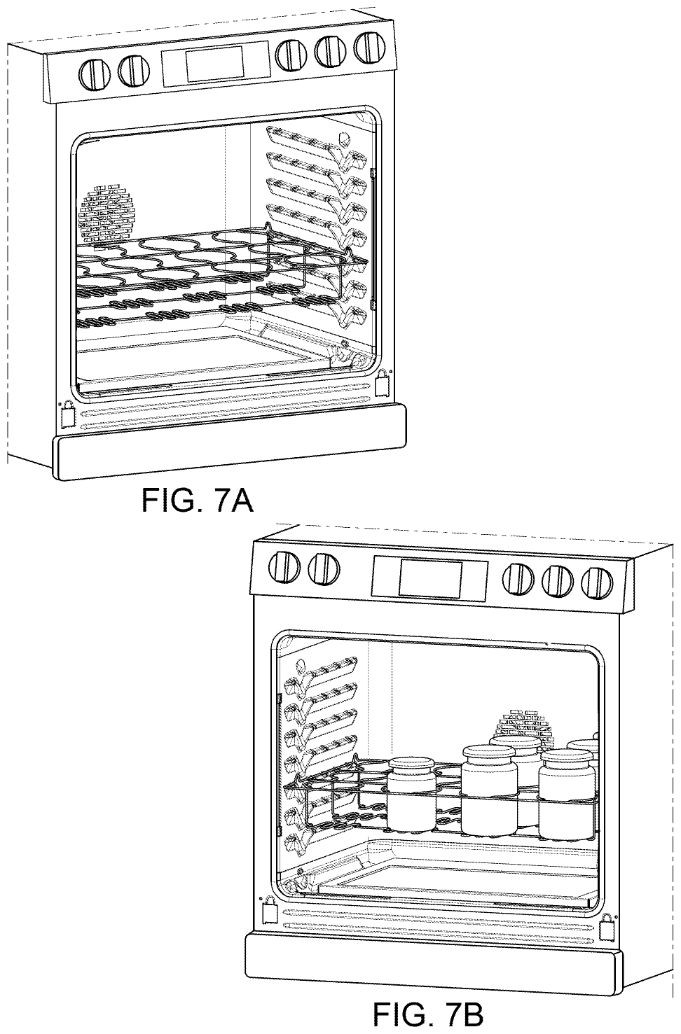

Empty containers 15 may be loaded into a specialized rack and placed into the oven cavity before or shortly after the initial pre-heat stage has been initiated. Referring to FIG. 6A-6C, the rack 100 is specially adapted so that the canning medium (e.g, hot, circulating air) can freely access substantially the entire periphery of the containers 15 during the air canning process. The rack 100 contains at least one lower wire support 101 upon which the base of the containers 15 rest when inserted. The rack 100 also contains a series of wire rings 102, which laterally support and stabilize the containers 15 when inserted. The lower wire support 101 and the series of wire rings 102 define respective receptacles 103 for the individual containers 15. The rack 100 contains a plurality of receptacles 103 in an array.

The wire rings 102 that confine the lateral movement of containers 15 may be provided in an array at a first level that is substantially planar with a perimeter of the wire frame 104 of the rack, and are defined by curved wire segments 102 that extend depthwise between cross bars spanning the width of the rack between lateral segments of the perimeter frame. Lower wire support 101 may be suspended from the wire rings 102. Alternatively, the lower wire supports 101 arranged together in a row can be formed from a single wire that is suspended from either end, either from laterally outermost curved wire segments 102 as seen in FIG. 6A, or from the lateral segments of the perimeter frame (not shown). As shown in FIG. 6A, the lower wire support 101 can define a plurality of container support segments arranged in a lateral subarray and formed from a common wire suspended from curved wire segments of laterally outermost ones of a first plurality of wire rings 102, also arranged in a lateral sub-array. The sub-array of container-support segments are aligned respectively in-register with and disposed beneath the array of wire rings 102. A plurality of such assemblies can be provided in the rack 100, i.e. to provide multiple rows (lateral arrays) of receptacles 103 for canning containers. The rack 100 may have conventional forward and aft rack stops 105, 106, which cooperate with conventional sidewall embossments in the oven cavity to fix the degree of insertion, as well as inhibit the removal of the rack at full extension to prevent tipping over.

Referring back to FIG. 4, in one embodiment, the initial pre-heat stage S1 concludes when the temperature sensor indicates that the temperature of the oven cavity has achieved the preheat temperature. In another embodiment, once the temperature sensor indicates that the temperature of the oven cavity has reached the preheat temperature, the air canning algorithm is configured to operate the at least one heating element and the convection fan, optionally according to a time duty cycle, to maintain the temperature of the oven cavity at the preheat temperature (optionally plus an offset) for a predetermined period of time. For example, temperature of the oven cavity may be held at the preheat (with optional offset) temperature for up to about 5 minutes, up to about 10 minutes, up to about 15 minutes, or up to about 30 minutes. In this embodiment, the initial pre-heat stage concludes once the predetermined period of time lapses. The predetermined period of time can be selected, for example, to facilitate effective sterilization of empty jars in the oven cavity.

Upon completion of the initial pre-heat stage S1, the air canning algorithm is configured to cause a user prompt to be issued. The prompt may be at least one of visual, audible or tactile, and is intended to notify the user that the rack holding the empty containers should be removed from the oven cavity, the containers filled, and thereafter returned to the oven cavity. Once removed, the (now-sterilized) containers are filled with the food or liquid item to be canned. The container openings are covered with respective caps and/or gaskets as conventional, which can be secured in place with bands which are manually screwed on over the ring of the container as known in the art.

Optionally, one or more intermediate pre-heat stage(s) may be executed immediately following the initial pre-heat stage S1 and prior to the post-heat (canning) stage. The intermediate pre-heat stage(s), if present, is/are operated upon completion of the initial pre-heat stage S1, and after the user prompt, but before initiation of a post-heat stage S2. For example, such an intermediate preheat stage can be used to restore the (now-filled) containers 12 to (or nearer to) the preheat temperature, from which they would have retreated upon being temporarily removed from the oven cavity to be filled.

After the user prompt, the oven cavity 12 may continue to be heated by running at least one of the plurality of heating elements 16, 18 and 20 to approach (or maintain in case the preheat- and post-heat temperatures are the same) the postheat temperature, optionally within a timed parameter. Alternatively, the intermediate pre-heat stage(s), if present, can be used for this purpose to bridge the preheat- and postheat temperatures (or to maintain temperature if those two temperatures are constant).

At a subsequent post-heat stage S2 of the pre-determined plurality of heating stages, occurring after completion of the initial pre-heat stage S1 (as well as after any intermediate stage(s) if present) and after the user prompt, the food is effectively canned within the oven cavity 12. The post-heat stage S2 can continue indefinitely as implemented by the air canning algorithm until manually deactivated by the user. Alternatively, it can continue until the expiration of a user-selected maximum air canning time. In still a further alternative, the post-heat (canning) stage S2 can continue for a predetermined period of time that has been preprogrammed into the air-canning algorithm based on the food selection identified by the user at the start of the algorithm. During post-heat stage S2, at least one of the plurality of heating elements 16, 18 and 20 is operated, optionally according to a specific duty cycle and preferably via PID control to maintain a precisely controlled postheat (canning) temperature.

According to the air canning method, during the post-heat stage S2 the air canning algorithm is configured also to operate the convection fan 24 to promote even heat distribution throughout the oven cavity 12. The fan 24 preferably operates full-time during the entire post-heat stage S2.

During post-heat stage S2, in the disclosed embodiment, the at least one heating element and the fan 24 are operated to maintain or hold the temperature of the oven cavity according to the postheat temperature, which may include a setpoint temperature plus an offset. As noted, the postheat temperature during the post-heat stage S2 can be the same as or different from the preheat temperature utilized during the initial pre-heat stage S1. Typically, however, the postheat temperature is greater than or equal to the preheat temperature. When the two temperatures are different, they may be related to a common setpoint temperature plus respective first and second offsets utilized in the initial pre-heat and postheat stages, respectively.

More specifically, the preheat temperature can correspond to a temperature lower than the user-selected (or preprogrammed based on user-selected food to be canned) air canning temperature, the preheat temperature being suitable for heating the empty jar to sterilize it but not necessarily as high as desired once canning begins. When utilized, respective offsets can be selected to correspond to the differential between the desired preheat and postheat temperatures based on a common setpoint temperature.

As will be appreciated, the respective offsets to the predetermined or user-selected set point temperature can be selected for any of food-specific or thermal-behavior-specific reasons (i.e. the particular thermal characteristics of the oven), and may be determined via an iterative process for that particular cavity to ensure consistent air-canning results. For example, an offset may be added to account for presence of a catalytic oven exhaust cleaner because such a system can increase the temperature of air in the oven cavity when turned on due to heat retention resulting from the heat guard. Other conditions for which an offset may be added can include, for example, the particular insulation efficiency, heat capacity and other thermal properties of the respective cooking appliance, heating rate (i.e. wattage) of particular heating elements, air-circulation rate and efficiency, the presence or absence of so-called hotspots or circulation deadzones within the cavity, etc., of which a user may not take account or be aware when selecting a particular desired cavity setpoint for air-canning.

A PID algorithm may be utilized for controlling the operation of the heating element(s) within the oven cavity 12 during the post-heat stage S2. PID control generally provides tighter temperature regulation around the target temperature. Briefly, a PID algorithm may calculate a gain by comparing an error of a detected temperature inside the oven cavity to a target temperature of the algorithm. In the case of a post-heat stage S2, the target temperature will be the desired postheat (canning) temperature, which may include the selected (or predetermined) setpoint temperature plus the second offset (if present). The error may be determined as a simple relationship between the detected temperature and the target temperature (e.g., a proportional gain), an accumulated error (e.g., an integral gain), a rate of change of error (e.g., a derivative gain), and/or other similar metrics.

PID control generally is known in the art and may be implemented in many ways. Indeed, such algorithms may be optimized according to a particular oven's thermal efficiencies and properties. For example, coefficients for the proportional, integral, and derivative gain calculations used in PID control may be tailored according to a particular cooking appliance.

Tight temperature control is desirable in canning operations because when the temperature fluctuates such that it falls too low, the bactericidal function for canned contents may not be adequately achieved. In contrast, when the temperature fluctuates such that it rises too high, the food(s) or liquid(s) may become discolored, lose nutrients, or become less palatable. Thus, PID controlled oven convection in air canning operations is preferable because it is capable of tightly-controlling a temperature very near a target (e.g. canning) temperature and is used in the below-provided exemplary embodiments during the respective post-heat stages (canning) S2. It is noted that the below-provided exemplary embodiments employ a PID algorithm that utilizes respective P-, I- and/or D-gains or gain components in order to determine when a duty cycle should be operative to regulate cavity temperature.

Upon completion of the post-heat stage (canning), the air canning algorithm is configured to cause a user prompt to be issued. The prompt may be at least one of visual, audible or tactile. In one embodiment, the user prompt may signal that the containers may be removed from the oven cavity for cooling on a countertop. Alternatively, the prompt is intended to notify the user that the air canning has been completed and that the air-canning algorithm is entering a cool down stage. During the cool down stage, the oven cavity 12 is cooled down by running the convection fan and deactivating all of the heating elements 16, 18 and 20, optionally until a predetermined cooldown temperature (e.g. room temperature) is reached, or for a predetermined cooldown time period. Once the cooldown temperature or cooldown time period is reached, the air canning algorithm is configured to cause a user prompt to be issued to notify the user that the containers are ready to be removed from the oven cavity for storage. The prompt may be at least at least one of visual, audible or tactile

The air canning methods can be used with either of an electric kitchen range or a gas kitchen range as described herein. The associated air canning algorithm, including instructions for implementing the air canning method upon initiation of the ‘Air Canning’ mode, may be configured to operate the plurality of heating elements 16, 18 and 20 and the fan 24 suitably in view of the particular appliance characteristics, including whether it uses gas or electricity to generate heat.

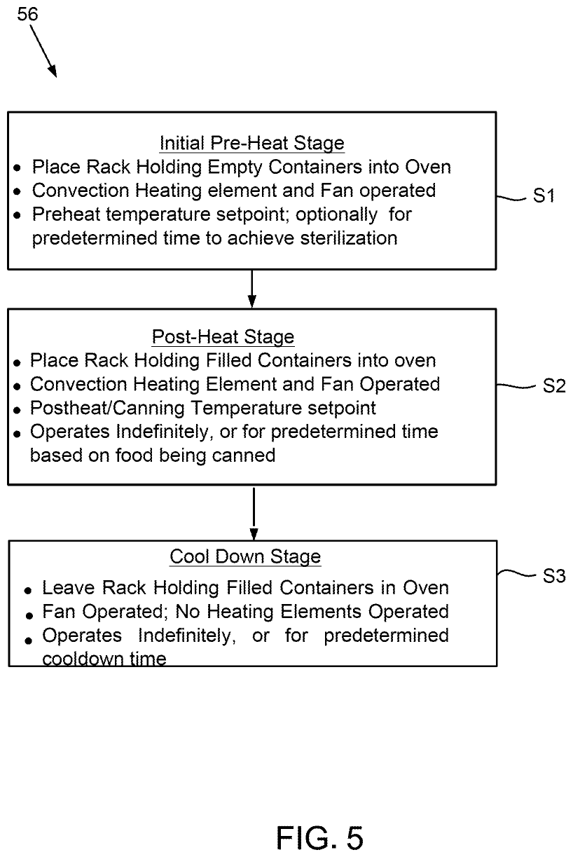

Turning to FIG. 5, a portion of an embodiment of the air canning algorithm is illustrated.

After selecting the ‘Air Canning’ mode via the user interface, the air canning algorithm is implemented to heat the oven cavity 12 and to can a food item using, e.g., the plurality of pre-determined heating stages of step 56 (FIG. 4). The user loads empty jars into the specialized rack and places the rack into the oven cavity. At the initial pre-heat stage S1-E, the convection heating element 18 and the convection fan are operated concurrently until the measured temperature in the oven cavity achieves (i.e., reaches or exceeds) a preheat temperature. Once the oven cavity achieves the preheat temperature, the air canning algorithm can start a timer for a predetermined period of time. The initial pre-heat stage S1 is completed when the predetermined period of time lapses.

Upon completion of the initial pre-heat stage S1, the air canning algorithm prompts the user to remove the specialized rack containing the empty (sterilized) jars from the oven cavity. The user loads the food to be canned into the heated jars. Once filled, the user covers the jar openings with caps/gaskets as noted above and loosely secures them (i.e. so that air still can escape around the loosely fitted caps), e.g., via conventional screw bands. Once all the containers have been filled and loosely sealed, the user returns the specialized rack holding the filled and loosely sealed jars to the oven cavity to begin the post-heat stage S2.

At the post-heat stage S2, the convection heating element is operated according to PID feedback control to maintain the oven cavity at the preheat temperature indefinitely until the user terminates the air canning mode, or until a predetermined period of time expires. The convection fan is operated during the entirety of the post-heat stage S2.

Once the post-heat stage S2 has been terminated by the user or the predetermined time has elapsed, the air canning algorithm informs the user that the oven is entering a cool down stage S3. e.g. via an audible or visual prompt. During the cool down stage S3, the heating elements are inactive and the convection fan operates during the entirety cool down stage, which can last indefinitely until the user terminates the program, or until the oven cavity has been cooled to a predetermined temperature, or until a predetermined cooldown period of time has elapsed. Once the cooldown stage has lapsed, the air canning algorithm prompts the user to remove the specialized rack from the oven.

In summary, a method 50 of canning food in an oven cavity 12 utilizes air, not liquid (e.g., water), as the canning medium. Using a dedicated air canning algorithm to control at least one of a plurality of heating elements 16, 18, and 20 and an associated fan 24, a temperature of the oven cavity 12 is adjusted in a plurality of temperature regulated cooking stages S1-S3. An initial pre-heat stage S1 includes temperature control targeting a preheat temperature. A subsequent post-heat stage S2 maintains the cavity temperature at a postheat (canning) temperature that can be the same as or higher than the preheat temperature, e.g. differentiated therefrom respective offsets from a setpoint temperature. During at least postheat, the heating element(s) 16, 18 and 20 operative during the stage preferably are operated to target the postheat temperature via PID control, and the associated fan 24 operates full-time during the stage.

The invention has been described with reference to the example embodiments described above. Modifications and alterations will occur to others upon a reading and understanding of this specification and can be made thereto without departing from the spirit and the scope of the invention as set forth in the appended claims. Example embodiments incorporating one or more aspects of the invention are intended to include all such modifications and alterations insofar as they come within the scope of the appended claims and their equivalents.

What we claim is:

1. A method for canning food, comprising:
receiving a user selection to activate an air canning mode including a pre-determined plurality of sequential heating stages in an oven cavity of a kitchen appliance;
receiving an empty container on a rack inserted into the oven cavity;
thereafter heating the oven cavity during a pre-heat stage of the plurality of sequential heating stages targeting a predetermined pre-heat temperature for a first predetermined period of time in order to sterilize the empty container;
thereafter filling the empty container with food to be canned therein; and
thereafter heating the oven cavity during a post-heat stage of the plurality of sequential heating stages with the now-filled container therein, targeting a predetermined post-heat temperature to thereby can the food in the container.

2. The method of claim 1, further comprising:
during said pre-heat stage, operating a convection fan and at least one heating element according to a pre-heat duty cycle to maintain the oven cavity at said pre-heat temperature for said first predetermined period of time; and
during said post-heat stage said convection fan and the at least one heating element are operated according to a post-heat duty cycle to maintain the oven cavity at said predetermined post-heat temperature.

3. The method of claim 1, said empty container being disposed in a receptacle of said rack adapted to individually receive the empty container therein, said rack being withdrawn from said oven cavity following said pre-heat stage to accommodate filling the container with said food, and thereafter re-received within said oven cavity prior to said post-heat stage.

4. The method of claim 2, wherein the at least one heating element is operated via a proportional-integral-derivative (PID) algorithm during the post-heat duty cycle.

5. The method of claim 4, wherein the convection fan is operated for a full duration of, and the at least one heating element is cycled on and off during, the post-heat duty cycle.

6. The method of claim 1, wherein the predetermined pre-heating temperature equals a predetermined pre-heat setpoint temperature plus a first offset.

7. The method of claim 6, wherein the predetermined post-heat temperature equals a predetermined post-heat setpoint temperature plus a second offset.

8. The method of claim 1, wherein the predetermined pre-heat temperature is between about 230° F. to about 250° F.

9. The method of claim 1, wherein the predetermined pre-heat temperature and the predetermined post-heat temperature are the same.

10. The method of claim 1, wherein the first predetermined period of time is about 15 minutes.

11. The method of claim 1, wherein the post-heat stage continues for a second predetermined period of time.

12. The method of claim 11, further comprising prompting a user to remove the rack from the oven cavity when the second predetermined period of time lapses.

13. The method of claim 1, further comprising prompting a user to remove the rack from the oven cavity to fill the empty container with said food when the first predetermined period of time lapses.

14. The method of claim 1, further comprising a cool down stage following the post-heat stage, where during the cool down stage the convection fan is operated and the at least one heating element is deactivated in order to cool down the filled container prior to removal from the oven cavity.

15. A rack for canning food in a kitchen range, the rack comprising:
a wire frame;
at least one cross bar spanning a width of the rack between lateral segments of the wire frame;
at least one lower wire support; and
a series of wire rings;
wherein the at least one lower wire support and the series of wire rings define a plurality of receptacles adapted to receive individual canning containers in the rack.

16. The rack of claim 15, wherein the wire rings are arranged in a planar array that is coplanar with the wire frame.

17. The rack of claim 16, wherein the at least one lower wire support is suspended from the wire frame at a level beneath, and is arranged substantially parallel to, the array of wire rings.

18. The rack of claim 17, the at least one lower wire support comprising a first lower wire support defining a first plurality of container-support segments arranged in a lateral sub-array thereof and formed from a common wire, the first lower wire support being suspended from curved wire segments of laterally outermost ones of a first plurality of said wire rings arranged in a lateral sub-array thereof, the sub-array of said container-support segments being aligned respectively in-register with and disposed beneath the array of said wire rings.

19. A method for canning food in a kitchen appliance, the method comprising:
receiving a user selection to activate an air canning mode including a pre-determined plurality of sequential heating stages;
loading a plurality of empty containers respectively into the plurality of receptacles in the rack of claim 15 and inserting the rack into an oven cavity of the kitchen appliance;
thereafter heating the oven cavity during a pre-heat stage of the plurality of sequential heating stages targeting a predetermined pre-heat temperature for a predetermined period of time in order to sterilize the empty containers;
thereafter removing the rack from the oven cavity and filling the empty containers with food to be canned therein;
thereafter receiving the rack with the now-filled containers back into the oven cavity; and
thereafter heating the oven cavity during a post-heat stage of the plurality of sequential heating stages, targeting a predetermined post-heat temperature to thereby can the food in the containers.

20. A cooking appliance, comprising:
a cabinet forming an oven cavity;
a convection heating system including a convection fan and a convection heating element for developing a flow of heating air within the oven cavity; and
a controller for separately controlling operation of each of the convection heating element and the convection fan for heating the oven cavity, the controller configured to operate in an air canning mode wherein during each of a pre-heat stage and a post-heat stage thereof the convection heating element is operated according to a proportional-integral-derivative (PID) algorithm,
wherein during the post-heat stage said controller operates the convection fan for a full duration of the post-heat stage and the convection heating element is cycled on and off, targeting a predetermined post-heat temperature that is the same as a predetermined pre-heat temperature targeted during the pre-heat stage.
